(19) United States
(12) Patent Application Publication
(10) Pub. No.: US 2018/0090989 A1
(43) Pub. Date: Mar. 29, 2018

(54) Multi Sensor Pack and Control of Energy Consumption Devices

(71) Applicant: Albert Subbloie, Orange, CT (US)

(72) Inventor: Albert Subbloie, Orange, CT (US)

(21) Appl. No.: 15/718,590

(22) Filed: Sep. 28, 2017

Related U.S. Application Data
(60) Provisional application No. 62/400,772, filed on Sep. 28, 2016.

(51) Int. Cl. H02J 13/00; G05B 15/02

(52) U.S. Cl. CPC H02J 13/0075; G05B 15/02

(57) ABSTRACT

A system which can curtail energy usage in response to increasing energy demands in order to avoid peak demand or demand based charges using networked adaptors and sensors. In certain aspects, adaptors are in wireless communication with a controller which is configured to monitor usage of the adaptors and control the adaptors as needed to respond to usage events or environmental conditions. A multiple sensor pack may be provided in wireless communication with multiple devices, or adaptors and the controls may be implemented based on readings from the sensors or adaptors or both.

### FIELD OF THE INVENTION

The following relates to systems for curtailing energy usage in response to peak usage events as well as a sensor pack and underlying software that enables granular control of electrical power using devices. In addition, the following relates to management of devices via a sophisticated software program and arrangement of hardware devices (IoT) where the devices use the sensor pack and/or include control and measurement features such that energy usage can be controlled on a granular level in response to demand based events.

### BACKGROUND OF THE INVENTION

Internet of things (IoT) devices are becoming more and more prevalent in both home and commercial settings. For example, thermostats such as the NEST® thermostat are designed to include a thermostat controller, temperature sensor and wifi module all in a single housing that can easily replace existing thermostats that are not “smart” or network enabled. While there may be some benefits in adding a controller to the existing heating configuration, the control and scheduling functions are only limited to the heating and cooling system. WiFi enabled switches exist such as the WEMO® by Belkin. This switch connects to existing wiring and includes a wifi module that connects to the internet. In both situations, the user is able to control the lights via one application and heating/cooling via another application. However, in a room with both a Nest thermostat and a WEMO switch, the sensors in the Nest thermostat do not communicate with the WEMO switch. Further, each of the sensors is purpose built for a single device, meaning the Nest sensor can only work to control the single thermostat to which it is connected.

In the commercial setting, electrical power usage can be a significant expense and it is difficult to determine where usage is occurring. Further, rates charged by a utility company can vary widely based on peak usage and/or time-of-day usage. For example, if a commercial location is below a particular threshold of power usage (kW), one rate may apply. If the same location surpasses this threshold, even if only for 30 seconds, a separate rate (higher) rate may apply for the month or even the entire year or more. Once this threshold is reached, power usage afterwards is billed at the rate triggered by the peak usage. This is true even if usage falls well below the threshold.

In many cases, certain lights could be dimmed or turned off or other modifications to usage could be made to a particular location's usage. The difficulty is that the meter that determines if the threshold is surpassed is only able to give usage metrics as to the overall location.

### SUMMARY OF THE INVENTION

It is therefore an object of the present invention to provide a system that can read and respond to conditions and usage on a much more granular level.

It is further desired to provide a system that can automatically respond to usage events and/or environment conditions to avoid excessive or elevated expenses.

It is further desired to provide a sensor pack that is separately connected to multiple networked energy consuming devices on a room by room basis to control usage on a more granular level.

These and other objects are achieved by providing a system which can curtail energy usage in response to increasing energy usage in order to avoid peak demand or demand based charges using networked adaptors and sensors.

In certain aspects, a multiple sensor pack is in wireless communication with multiple devices, or Adaptors. The Adaptors are in wireless communication with a controller which is configured to monitor usage of the Adaptors and control the Adaptors as needed to respond to usage events or environmental conditions based at least in part on readings from the sensor pack.

In one aspect the management of energy usage includes a plurality of adaptors which measure energy usage at the adaptor and include controllers for controlling energy usage. A sensor pack has a housing containing a plurality of sensors and is in wireless communication with one or more of the adaptors. The housing of the sensor pack is separate from the adaptors such that the sensor pack is configured to be positioned nearby, but untethered remote from one or more of the adaptors. A computer is in communication with the plurality of adaptors and sensor packs and receives energy usage data from the adaptors and sensor data from the sensor pack. Software executes on the computer which controls energy usage at one or more of the plurality of adaptors based on control data which includes said sensor data.

In one aspect the control data further includes a ruleset for reducing energy usage at one of the plurality of adaptors based on a threshold of energy usage. In another aspect the threshold is associated with a peak demand threshold indicative of a change in cost per unit of energy used if said peak demand threshold is surpassed.

In other aspects an energy demand management system is provided which includes a plurality of adaptors which measure energy usage at the adaptor and include controllers for controlling energy usage. A computer is in communication with the adaptors via a network. Software executes on the computer and generates control inputs for transmission to at least one of the plurality of adaptors. The control inputs are generated based on measured energy usage of the adaptors in comparison to a threshold of energy usage related to the plurality of adaptors, the threshold of energy usage indicative of a peak demand value of energy usage where a per usage charge for energy usage is greater when the threshold is exceeded.

In other aspects an energy demand management system includes a plurality of adaptors which measure energy usage at the adaptor and include controllers for controlling energy usage. A computer is in communication with the adaptors via a network. Software executes on the computer and generates control inputs for transmission to at least one of the adaptors. The control inputs are generated in response to an electronic request received from a remote computer associated with an energy ISO or grid operator. The electronic request further indicative of a request to reduce energy usage. A profile, a programmed series of events/actions, is stored on a storage accessible by the computer and the electronic request is compared to the profile and the computer generates the control inputs to adjust energy usage of at least one of said plurality of adaptors.

In other aspects an energy demand management system is provided for minimizing energy usage above a peak demand value associated with a facility. The system includes adaptors which measure energy usage and include controllers for controlling energy usage. The adaptors are configured to control energy usage devices at the facility downstream of an electrical meter of the facility. A computer communicates the adaptors via a network and software executes on the computer. The software is configured to generate a control input for transmission to the adaptors. The control input is generated based on energy usage in comparison to a threshold of energy usage and a control rule. The control input allows for control of one or more of the energy usage devices. The threshold of energy usage is associated with the peak demand value of electrical energy usage for the facility where a charge for energy usage by the facility below the threshold is of a first value and the charge for energy usage by the facility above the threshold is of a second value greater than the first value. The second value is applicable based upon the threshold having been exceeded. The charge for energy will remains at the second value for a time period after the threshold is exceeded so that the charge for energy usage by the facility is of the second value despite the energy usage of the facility being below the threshold. The control input curtails energy usage of one or more of the energy usage devices at the facility to avoid the peak demand value of energy usage of the facility from rising above the threshold.

In certain aspects the control rule identifies at least one of the energy usage devices whose usage is not curtailed in the event of the threshold being anticipated to be exceeded. In other aspects the control rule identifies at least one of the energy usage devices and is associated with a condition for when usage thereof is curtailed in the event of the threshold being anticipated to be exceeded. In still other aspects the control rule identifies at least one of the energy usage devices and is associated with a condition for when usage thereof is not curtailed in the event of the threshold being anticipated to be exceeded. In yet further aspects the control rule identifies at least one of the energy usage devices which is turned off in the event of the threshold being anticipated to be exceeded.

In some aspects the control rule includes a single rule for one or more of the energy usage devices. In other aspects the control rule includes a one or more rules for one or more of the energy usage devices.

In certain aspects the peak demand value related to usage via the electrical meter. In certain aspects the electrical meter is a utility company electrical meter used for determining a charge for energy usage. The control rule may further include a ruleset for reducing energy usage at one of the adaptors based the threshold of energy usage.

In other aspects the system includes a sensor pack having a housing containing a plurality of sensors and in wireless communication with one or more of the adaptors. The housing is separate from the adaptors such that the sensor pack is configured to be positioned remote from one or more of the adaptors and to have a power source separate therefrom. In certain aspects, the sensor pack communicates with the one or more of the adaptors via Bluetooth Low Energy (BLE).

In other aspects a profile is stored on a storage accessible by the computer and when the threshold is anticipated to be reached, the profile is indicative of at least one modification to curtail energy usage and maintain usage below the peak demand value associated with the threshold. In certain aspects, the value of the peak demand value and the threshold are the same.

In certain aspects the peak demand value is measured in units of electrical power. In other aspects the peak demand value is measured in units of electrical energy.

In yet other aspects a system is provided for management of energy usage. The system includes adaptors which measure energy usage at the adaptor and include controllers for controlling energy usage. A sensor pack is provided having a housing containing sensors and in wireless communication with one or more of the adaptors. The housing is separate from the adaptors such that it is configured to be positioned remote from one or more of the adaptors and to have a power source separate from the one or more of the adaptors. A computer is in communication with the plurality of adaptors and receives energy usage data from the adaptors and sensor data from the sensor pack. Software executing on the computer controls energy usage at one or more of the plurality of adaptors based on control data which includes the sensor data.

In certain aspects the power source separate from the adaptors is a battery. In other aspects the housing is configured to allow for removal or addition of some or all of the sensors. In certain aspects the housing contains three or more sensors selected from the group consisting of: temperature sensor, humidity sensor, light sensor, occupancy sensor, audio sensor, infrared camera sensor, air quality sensor, and smoke sensor.

Other objects are achieved by providing an energy management system for controlling energy usage at a facility. One or more voltage regulation devices are configured to modify an electrical potential drawn downstream of an electrical meter of the facility. A computer is in communication with said one or more voltage regulation devices. Software executes on the computer and is configured to generate a control input for transmission the voltage regulation device. The control input is generated to modify the electrical potential. The control input is generated in response to a request from an energy supplier to reduce usage.

In certain aspects, the computer and one or more voltage regulation devices communicate via a wireless connection

In other aspects, the control input is generated based on a threshold of energy usage associated with a peak demand value of electrical energy usage for the facility where a charge for energy usage by the facility below the threshold is of a first value and the charge for energy usage by the facility above the threshold is of a second value greater than the first value, wherein the second value is applicable based upon the threshold having been exceeded. Further, the charge for energy usage remains at the second value for a time period after the threshold is exceeded such that after exceeded and during the time period, the charge for energy usage by the facility is of the second value despite the energy usage of the facility being below the threshold. The control input causes the electrical potential drawn downstream of the electrical meter to be reduced to avoid the peak demand value of energy usage of the facility.

In other aspects, the control input is generated in response to a request from an energy supplier to reduce usage.

Other objects of the invention and its particular features and advantages will become more apparent from consideration of the following drawings and accompanying detailed description.

### BRIEF DESCRIPTION OF THE DRAWINGS

FIG. 1 is a functional flow diagram according to the present system and method of energy consumption management.

FIG. 2 is a functional flow diagram showing features of FIG. 1.

FIG. 3 is functional flow diagram showing the sensor pack described herein installed and being used, for example in the system of FIG. 1-2.

FIG. 4 is a functional flow diagram of system and method of energy consumption management according to another embodiment.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

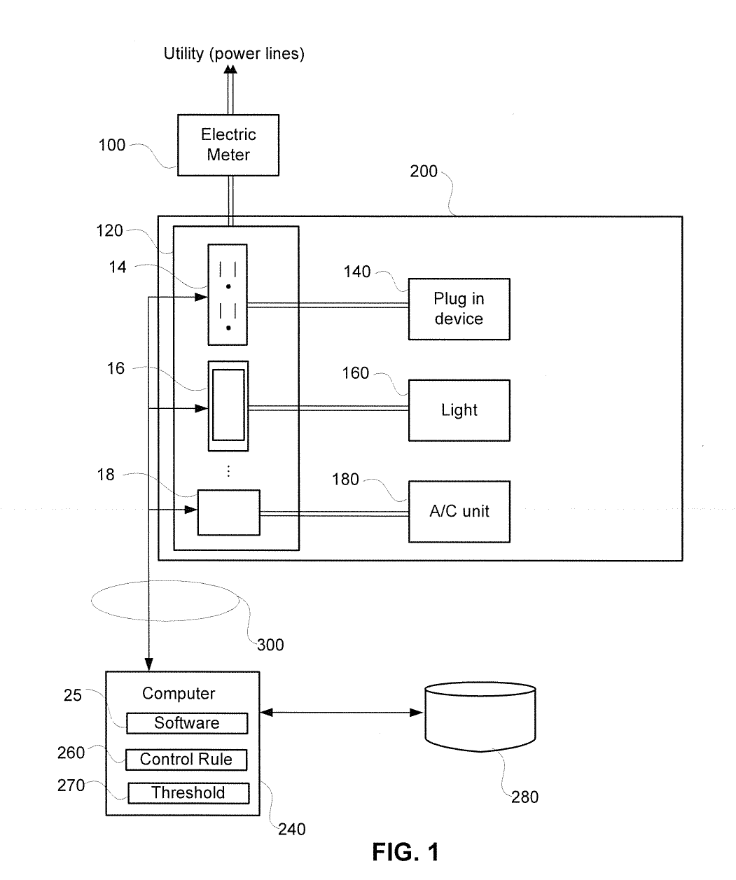

FIG. 1 shows a facility 200 with a number of electrical energy usage devices 140, 160, 180 connected to adaptors 14, 16, 18. Examples of devices are shown (plug in device, light, air conditioning unit), but it is understood that other electrical devices can be used and those shown are merely exemplary and that many more electrical energy usage devices can be present at the facility 200 downstream of the electric meter 100. The electric meter 100 is typically installed or supplied by or for the benefit of the utility company so that this company can charge the facility the appropriate amount of money for electrical usage. As described below, the way in which charges are made and the rates therefore can change significantly depending on a number of factors. Some simply use different rates for times of day. Other models charge based on what is referred to as a peak demand value.

In order to avoid peak demand based charges, the system includes software 25 on a computer 24. The computer communicates over a network 300 with the adaptors to controls the adaptors 14/16/18 in a way to either shut off or curtail usage of electricity to lower the amount of demand at a particular time or time period. It is understood that the computer 240 could be local or remote to the facility and the network can 300 can, in some examples, be a local network or public internet to allow for communication and control off site. It is also understood that combinations of local and remote computers/networks and servers may be used within the scope of what is shown in FIG. 1. Also shown in FIG. 1 is a storage 280 which may store historical data, profiles, rules and other information used by the software in implementing the controls. The storage may be local, or remote (i.e. networked). It is further understood that the control rules 260 and thresholds 270 may be stored on the storage 280

As one example of when peak demand becomes an issue, if every electricity usage device in the facility 200 is running at full power, this would likely result in the peak demand value being exceeded. The software 25 therefore uses control rules 260 and thresholds 270 to curtail usage of devices which can be shut off or reduced. As but one example, in a manufacturing facility on a hot summer day, the office component of the facility 200 may be using air conditioning at full power. The manufacturing floor may have large electric ovens used within the manufacturing process. If both are actively drawing full power at the same time, it is possible that the electricity demand will exceed the peak demand value if no action is taken. In this example, the software would recognize draw of power and that it is anticipated for demand to exceed the peak demand value, if only for 10 minutes. In this instance, the oven on the manufacturing floor may have priority over the air conditioning unit because the office area is already relatively cool. Therefore, the software and control rules would see this usage data and turn off the air conditioning unit or run the air conditioning system at a setting that reduces power usage. This would in turn allow the oven, which may be more critical, to keep running normally while avoiding the peak usage that results in an increased rate from the utility even if the actual peak usage of the facility is only above the peak demand value for 15 minutes. It is especially useful to be able to avoid exceeding the peak demand value because once exceeded, the rate charged will often be the rate above peak demand value even if actual usage falls well below that peak demand value. This could hold true for days, weeks, months or even longer such that the utility charges double (for example) just to make the peak demand available in case needed even if that peak value is rarely if ever reached again.

FIG. 1 also shows a voltage regulator 120. It is understood that although one is shown, multiple may be used. For example, the voltage regulator 120 is configured to control the voltage to the three adaptors 14, 16, 18 such that the voltage or electrical potential to the devices 140, 160, 180 is controllable. Certain devices may not be amenable (or may be less amenable) to operation at reduced voltages. In this case a voltage regulator may not be positioned between the power source (i.e. panel/meter) and the device whereas other devices amenable to voltage control may have a voltage regulator on their circuit. The voltage regulator in certain aspects is wireless controllable to reduce potential when needed. One example where this may be needed is in reference to a demand response event where the utility or supplier needs usage reduced to avoid energy shortages. Other events may include where the peak demand of the facility is approaching the point where there is a higher charge for usage based upon the peak demand having been reached or exceeded, regardless of whether the demand stays at the peak value or not. Thus, the voltage regulator can reduce the voltage of devices amenable to this control parameter to reduce the energy consumption of the appropriate devices. It is understood that the specific example devices shown in FIG. 1 are for purposes of illustration and do not limit the types of devices that could be used in the system. Although described as downstream of the utility meter, it is possible that the EVR is positioned upstream thereof in certain embodiments.

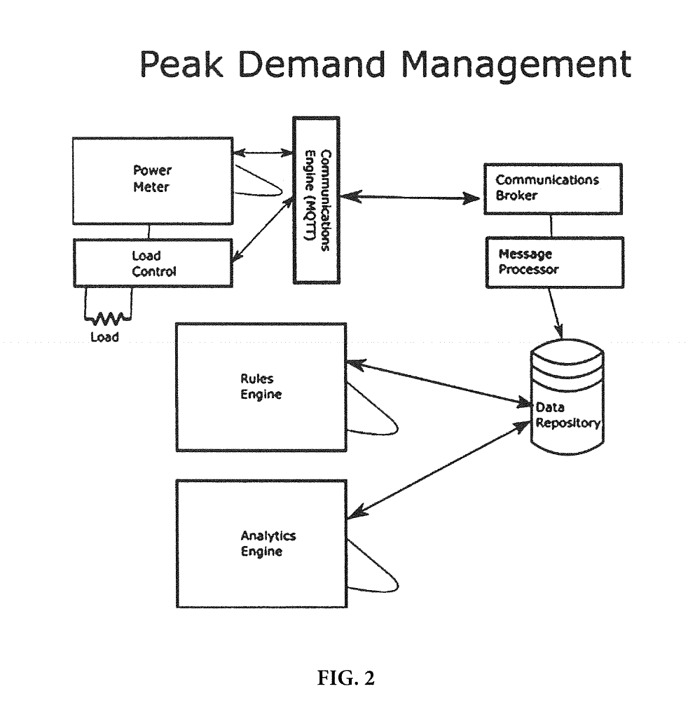

FIG. 2 shows details of the adaptors which may include a power meter and a load controller in communication with a communications engine (such as MQTT). A communications broker and a message processor enable communication of data between the adaptor and the data repository. This communication may be usage data being transmitted to the data repository, alternately, control inputs may be generated by the rules/analytics engine.

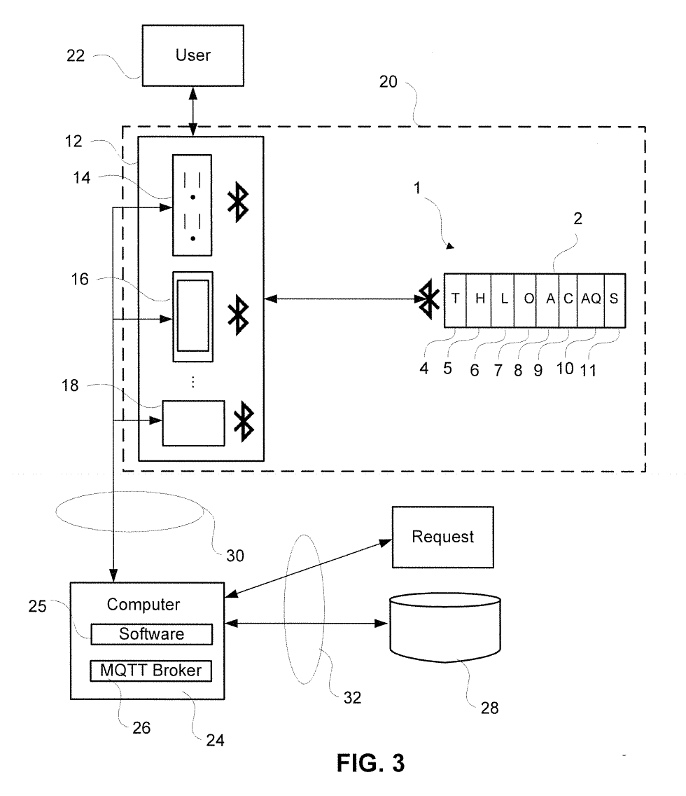

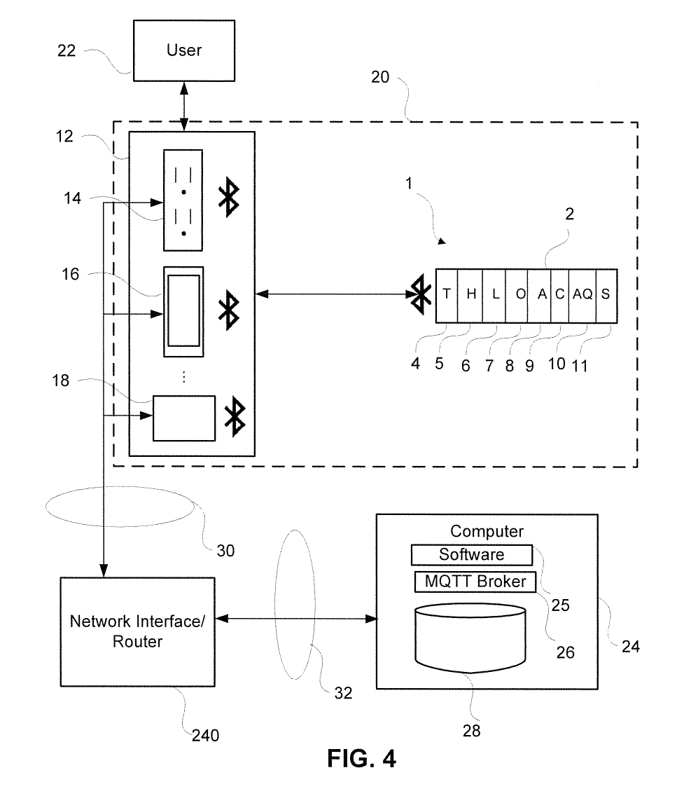

Referring to FIGS. 3-4, adaptors 12 (generally) such as outlets 14, switches 16 and other devices 18 are positioned throughout a room 20. The adaptors 12 include one or more of wireless communication hardware, energy consumption measurement hardware and control hardware. Sensor pack 1 includes a housing 2 with multiple sensors 4-11. The sensor pack 1 may be mounted to a wall or other location within room 20. Sensors include a temperature sensor 4, humidity sensor 5, light sensor 6, occupancy sensor 7, audio sensor 8, infrared camera sensor 9, air quality sensor 10 and smoke sensor 11. These are just some examples of sensors that can be used and it is understood that other sensors may be included within the housing. It is further understood that although a single sensor pack 1 is shown in the room 20, multiple sensor packs can be installed as needed to properly read the conditions within a particular room or area. The adaptors 12 communicate with sensor pack 1 via Bluetooth Low Energy (BLE) or other suitable wireless communication. In this way, the sensor pack 1 includes a separate power source from the adaptors 12. The power source may be a battery and due to the BLE communication protocol, the battery life can be on the order of multiple years.

The temperature sensor 4 provides granular temperature monitoring for a particular sensor location. Generally, the sensor is capable of measuring temperatures between −30 F and 180 F, but other ranges are contemplated. The humidity sensor 5 detects relative humidity in the area of the sensor. Exemplary range of readings is 0-95%. The data from this sensor can be used to affect change in HVAC settings or air quality systems and trigger alerts for over or under humid conditions. The light sensor 6 measures ambient light in the area of the sensor. This data can be used to dynamically adjust lighting levels and take advantage of natural light. Alerts can be triggered for under/over lit conditions. The occupancy sensor 7 detects occupancy in the vicinity of the sensor. Occupancy can trigger profiles of the particular occupant or to activate various functions of the networked sensor. The occupancy sensor could also include a Bluetooth connection, RFID or other sensor that determines when a particular device associated with a particular user profile is in the room. For example, a particular user's phone being present usually indicates they are present. Alternately, an adaptor 12 within the room may pair with the user's phone instead of the sensor pack 1. In addition, many buildings have keycard access and the keycards are individualized such that when detected in a particular room, this is generally where the person associated with such keycard is. The camera 8 can be used for added video surveillance and building security. In addition, the camera can be used to determine occupancy of the building for determining environmental adjustments. For example, a room with 10 people would heat up faster than the same room with 1, thus HVAC controls can be adjusted to input less heat or increase cooling (depending on the particular conditions required). The Audio sensor 9 promotes enhanced workplace safety and security. The sensor capability also enables voice command activation to control environmental conditions of the room. The air quality sensor 10 can detect CO2 or other parameters to ensure that workspace air quality is within an acceptable range. If the air quality parameters are outside acceptable ranges, the one of the adaptors 12 may include a controlled vent 18 which can open to introduce fresh air into the room. Smoke sensor 11 can trigger alerts when smoke levels are above an acceptable range. This can also be tied to a security monitoring system via one of the adaptors 12 such that a message can trigger a fire alarm. In this scenario, active electrical devices may be shut off to reduce the spread of fire.

The adaptors 12 also include wireless communication hardware that communicate with a computer 24 over a network connection 30 such as local internet. The controller may include a MQTT broker 26. MQTT (aka MQ Telemetry Transport) is an ISO standard publish-subscribe based lightweight messaging protocol for use on top of the TCP/IP protocol. MQTT is especially useful because it uses a minimal amount of bandwidth to communicate. It is understood that other communication protocols may be used.

In the embodiment shown in FIG. 3, the adaptors 12 are connected to a router 240 and communicate via public internet 32 with the MQTT broker 26 and the offsite database 28.

The controller is programmed to modify usage via the adaptors 12 based on overall usage and based on sensor readings from the sensor pack 1.

The sensor pack 1 is paired with one or more adaptors 12. The sensor pack 1 may be comprised of multiple modules, where each sensor is one module. The modules may be selectively selected and inserted into the housing 2 to configure the sensor pack 1 for the particular room. The housing would contain the power and BLE communications hardware. Additional blank modules can be provided to slide into the housing 2 to fill empty space. The readings from the sensors 4-11 are used to control multiple adaptors 12. For example, a single sensor pack 1 can provide readings to enable control of multiple outlets, switches, lights, thermostats, vents and other energy using devices.

Currently a facility/building entity is managed on an area by area basis using a loosely coupled collection of sensors. The sensor pack provides a fine grained approach to environmental sensing within individual spaces/rooms within a building. The sensors 4-11 may communicate on an event driven basis. For example, when occupancy changes, a message is sent so that the information is not streamed continuously. The same holds true for temperature or other conditions. This reduces power consumption by the sensor pack 1 and thereby increases battery life. When the message is sent to the computer 24, it is then communicated to the offsite database 28 via public internet 32. In this way, the facility usage and status can be monitored on a room by room basis from the database 28. The computer 24 can also be programmed to implement various profiles. The profiles can be based on particular users or overall system profiles. In addition, the profiles can take into account the usage of the facility as a whole as compared to rate based targets or thresholds.

For example, if the rate per kilowatt charged increases if usage passes a certain threshold at any given time, there may be a higher rate for electricity usage that applies thereafter. The facility profile can be configured such that when usage begins to approach this threshold, power consumption is reduced where possible. For example, lights may be dimmed to reduce power consumption. In addition, normal occupancy rules may require shutoff when no movement is detected in 5 minutes. In a scenario where power usage needs to be reduced, rooms with activity closest to 5 minutes may be shut off first until power usage is low enough.

The system can also receive user 22 input to establish profiles for the particular user. As shown in FIG. 2, the user 22 can connect directly to the adaptor(s) 12 and the connection to one adaptor can enable the user to control other adaptors within the room. It is understood that the user would connect with a computer such as a laptop, tablet or mobile phone. In addition, the user 22 may be able to connect to the computer 24 via wifi or local internet 30 or alternately via public internet 32. It is understood that the system can be configured in many different ways to enable user 22 to establish control profiles and other settings for the room 20 or the facility in general, depending on the user's login permissions.

When a profile is established, the user may input their ideal room temperature, their desired lighting profile, their curtailment tolerance level during demand curtailment and various other parameters. The system may also be configured to suggest standard profiles. This user may also establish a link to their mobile phone, which can provide location information so that it can be determined who is present at the facility/room on any given day. The temperature of shared spaces can be adjusted to reflect who is actually present or expected at the facility at any given moment. So, if as a group, the preferred temperature is 72 degrees either by majority or super majority, shared spaces will be controlled to 72 degrees. In order to enable the HVAC system to be configured to accomplish room by room temperature adjustments, vent openings can include a motorized control that retrofits to existing manual vent adjustment mechanisms. In alternate configurations, replacement vents may be used. These vent dampers can be considered one of the many options that could be encompassed by adaptor 18.

The software 25 provided can control the various features described herein.

The software provided herein is enabled to control energy consuming devices in a more efficient way. Most Internet of Things (IoT) devices such as outlets and switches are simply configured to enable wireless control without measurement of usage. But, placing the control and measurement of energy in the same IoT device provides significant benefits. For example, see U.S. Pat. Nos. 8,140,279, 8,396,608, the content of which is incorporated by reference herein. In order to take advantage of the systems disclosed in these patents, a control solution is contemplated to manage usage based on measured usage in a more granular way and to react accordingly to avoid peak demand rates.

Therefore, it is desirable to provide a system that efficiently manages energy usage using device based, or circuit based, or a combination thereof, measurement and control. Significant investment was made to develop this capability through several generations of integrated software and a variety of specialized hardware devices (These hardware devices are often referred to as “Internet of Things”, or IoT). The system couples integrated software and IoT hardware to provide a unique control and measurement capability in any facility that uses energy. The software is cloud based, but can also operate behind a firewall for a Company. The integrated IoT devices include, but are not limited to specialized light switches, dimmers, outlets, thermostats, power strips, power packs, circuit meters, sophisticated sensors, etc. These devices have energy meters embedded in them along with various control mechanisms that can communicate real time wirelessly or through Bluetooth® connectivity with each other integrated seamlessly to the comprehensive proprietary software that we developed to manage an entire facility and enterprise wide IoT device network. This integrated system can produce real time granular analytics on energy usage at levels within a facility and enterprise that was never before possible.

The software is comprehensive and enables total real-time visibility on actual energy usage in the entire facility, and equally important can be configured to automatically control each IoT device individually, or any group or combination of devices within or across enterprise facilities through commands or automated rules or user configured workflows. It is also possible for these IoT devices to be controlled manually as an override or alternative when desired or necessary.

Managing energy demand is important in a world with limited energy resource for the purpose of reducing waste, reducing global warming through reduction in carbon emissions, by using more efficient systems and methods. This disclosure describes two primary functions for managing energy demand functions in the marketplace, one is called Peak Demand Management (PDM), and the other is called Demand Response Management (DR). These demand management functions are similar, but provide unique benefits to both the users and suppliers of energy.

The concept of Demand Management is not new. For example, many companies exist that provide consulting services to reduce energy usage by sealing gaps, installing energy efficient light bulbs and more efficient heating and cooling systems. But, the system, method and software described herein enables automatic management of Demand Management in a unique way not previously possible or contemplated. For both PDM and DR, the system provides a unique method of controlling and measuring either one IoT device or any combination of multiple IoT devices for the purpose of curtailing a predetermined and calculated or desired energy demand load which is typically measured and billed in Kilowatts (kW).

Peak Demand Management (PDM)

To understand how we address PDM, it is important to understand how the utility bills are structured to charge for the use of energy in the commercial marketplace for enterprises large or small. In many states in the US, the bill is broken out into several different billing segments, each billed and calculated differently. The most basic charge method that most people understand is the Generation Services Charge segment of the bill. This charge typically represents approximately 50% of the bill and is billed as a rate for the amount of time that electricity is used for. This is called Kilowatt Hours, or kWh, meaning a specific rate charge for one hour of kW used. A kW is equal to 1,000 watts. The second segment of billing which is commonly called demand charge is the least understood billing segment, and is structured very differently than the kWh charge method. This segment of the bill can account for approximately 30% or even 50% of the entire bill. The demand charge is the peak use of electricity in a facility within a defined interval (typically 15 minutes) as measured by the utility at the utility meter. This peak is locked in by the utility and forms the level of charge in the monthly bill for the entire month, or in many cases, for an entire year. The notion of demand charges and peak demand, simply because many things were running at the same time at that one moment, is difficult to understand. Many business oriented people are not very aware how demand charges work. This invention creates a unique ability to mainstream the management of this often misunderstood expense through use of IoT controllers to manage usage.

Current methods of energy management provide very little visibility into all of the individual energy “use points” and their corresponding “real time” kW load within the facility. All of these “use points” are located behind the utility meter which typically is situated outside a facility. These “use points” are all of the control points used to manage energy in the facility, including but not limited to light switches, outlets, power strips, thermostats, power packs, machine loads, etc. within a facility. The utility meter only measures the total aggregated picture of kW usage for an entire facility and only for the purpose of billing the customer. The system, including all of the IoT devices integrated into the cloud based software is unique because it can measure and simultaneously control energy usage to more granular levels within any facility. The system is designed to replace the traditional control mechanisms like light switches, outlets, thermostats, power strips, power packs, and machine switches and outlets, etc. with new IoT devices that enable control and kWh/kW measurement at each of these points. Systems today are not efficient given they typically measure at the circuit breaker level for entire circuits on that power line.

The system therefore enables management of this peak demand charge in a way never before possible or practical. The system provides more granular control and real time measurement to a greater level of detail, and with more simple and easy on-going set up and management through the unique comprehensive software and IoT hardware connected and integrated through a wireless network. The system also collects much more usage data real time and then intelligently uses this for data for analytics to predict, alert, report, measure, and control energy demand better.

The system is installed through specialized IoT devices placed at many of the control points in a facility, such as light switches, dimmers, outlets, thermostats, power strips, circuit meters, sophisticated sensors etc. The software is connected real time wirelessly to each of these devices through an existing wireless network in the facility, or through a specific wireless network that is implemented, or a combination of both. The peak demand charge is displayed on the monthly utility bill and displays both dollars charged and the peak use in kW. Depending on the rate/tariff structure as defined by the local Department of Public Utility Control, this may be a peak from a prior point in time. Further, this actual peak point in time is frequently not displayed on a bill by the utility making this area very difficult to manage.

The devices are installed in a variety of pre-selected points of measurement and control, and will automatically measure the total usage of a facility rolling up to the utility meter. The system places a facility level meter in the same top aggregate level as the utility meter, so the system knows when the expected prior billed peak in kW is approaching. In the software, a profile or series of profiles are configured. These profiles can be a group of IoT devices that can control the use of energy, including but not limited to light switches, power strips, power packs, outlets, thermostats, machine controls, etc. This group of devices or profiles can be triggered through a work flow when the peak kW level is approaching a predefined threshold, the profile executes automatically, or sends an alert to request execution which can then be triggered through an executed command. There are several methods of curtailing this demand. First, it is sometimes possible to automatically curtail this peak before it happens. This is possible in a situation where there are many energy devices being turned on incrementally raising the peak in a ramped manner that the system can actually monitor and then be triggered to curtail before the peak is reached. This can include, but is not limited to “half bank” lighting in certain areas that support this, dimming if it is available in the facility, changing the temperature requested by several degrees, or simply shutting down certain things for short durations, or even staggering “on/off” conditions of multiple equipment types like AC units or other categories or equipment or machines. For example, if a cooling system is comprised of multiple AC units/compressors that run 25% of the time, an IoT device can be installed to control the timing of when the AC units turn on and draw power. This way, all AC units do not simultaneously turn on and push usage over the peak or set threshold.

Such actions enable the kW peak to be managed below a target threshold and therefore lowers the billed charges for the month and year. By using this approach, a company can pre manage the peaks at any time, and do so without ever having to introduce a manual step. Of course as noted, manual steps or simple confirmation steps can be inserted if an organization prefers that.

While managing peak consumption can be accomplished through a set rules, a second more sophisticated method can be accomplished. Since the system provides a variety of granular energy use data, this historical data coupled with real-time analytics produced through the integrated system can be used to optimize peak demand management intelligently by predicting peak events either as they are occurring or prior to them even happening so curtailment can be triggered or executed in a timely fashion to avoid peak demand events. This multi-tiered approach takes advantage of fined grained metering at the IoT device level and applies real-time analytics coupled with historical trend data to offer an optimized approach for demand management. For example, the system will evaluate the real-time energy consumption in an area of a facility and assess the business activity and population density associated with the area and adjust lighting and HVAC conditions accordingly. Other examples of optimization inputs include assessing the real-time price of energy against weather forecasts and business activity coupled with the ability to control energy consuming building systems at all levels down to the individual device within a room. The system provides numerous simple and comprehensive control options to manage peak demand that will minimize energy cost with little to no impact on the business activity or building environmental conditions. The analytics framework of the solution will utilize intelligent calculations based on multiple input variables to dynamically manage peak demand. Some of the input parameters produced by the system that are utilized to develop this intelligent PDM solution includes but is not limited to:

Current energy demand (building level)

Current energy demand (group level)

Current energy demand (IoT device level)

Time of day

Day of week

Weekend or Holiday

Business activity schedule

Employee population (real-time)

Population density (real-time)

Employee presence by area

Current facility outside temperature

Temperature forecast

Average facility temperature

Room level temperature readings

Internal CO2 readings (building and room level)

Real-time energy price

Historical building population trend data

Historical energy price data

Historical energy consumption

Demand Response Management (DR).

The second method of managing energy demand is called Demand Management, often referred as DR. Using the system, a similar approach as PDM can be used to support Demand Response. To better understand this application, one must understand the DR marketplace dynamics. Energy is a limited resource, and it is a “real time” needed resource, meaning at any point in time there needs to be enough energy to support the demand needed. Therefore, the Utility's or regional Independent Systems Operators' are forced to predict an expected “demand need” to insure they are ready to deliver what is needed, and when it is needed. It is very difficult to store energy, other than expensive batteries with limited storage, or complex Gyro fly wheels that can extend energy by only mere seconds. The problem lies in the unexpected demand that naturally occurs across all of the Utility customers on the grid. As a result, the Grid can possibly be caught without enough energy being created to support the demand at any point in time. When this happens, disaster strikes possibly resulting in widespread blackouts which are very expensive and potentially dangerous. As a result, the Utility's and regional ISO's have developed a program called Demand Response (DR), in which the customer can be compensated when they qualify and subscribe to this program for being prepared and able to demonstrate their ability to curtail energy with a reasonable time notification of hours or sometimes days. This program is typically available to larger enterprise customers, and provides an overall buffer for the Utility's and ISO to rely on in the event they need an immediate relief or curtailment, which can prevent the condition of supply being too low to meet expected demand at any point in time. The investment the Utility's and the ISO make to pay for this program is much less than the costs of maintaining additional energy capacity reserves, or the potential negative impacts of brownouts or blackouts.

As noted, these programs have traditionally been limited to larger consumers of energy. The current methods these organizations use to curtail this demand on short notice is very complex, expensive, and difficult to manage efficiently, which as a result has required third parties to manage on their behalf which come with more costs and complexity. There are many variables which are challenging and inefficient, all of which the system makes much simpler. Some of these variables include:

(1) The method of curtailing the demand when the Utility/ISO makes the request for this to happen. (2) The lead time the Utility provides to curtail the demand within any company and facility. (3) The expense of paying third parties to assist in setting this up, and managing the execution given the complexity. (4) The requirement to demonstrate the ability to curtail demand, by performing a certain number of dry runs of this curtailment as a prerequisite of participating in the DR program. (5) The complexity of measuring the specific kW load being curtailed before, during and after in a very transparent manner.

By removing the complexity and expense of all of these challenges, the system can mainstream DR more than ever before.

In the current marketplace, there are primarily two alternatives used to meet Demand Response requests to reduce both kW demand and kWh usage. The 2 options for curtailment are: (1) To shut off or reduce usage internally. (2) To use an alternative source of generation internally including but not limited to solar, fuel cells, or turbine generators.

These two are different in that the first one curtails usage, and the second simply replaces usage and relies less on the need to “reduce” as the method of achieving the committed reduction. Of course the second method can be complex and expensive. The solution is more focused on the first curtailment method which uses fast reacting reductions in existing demand to achieve the DR solution. The second method has many challenges, all of which have hampered the success of DR as a mainstream offering. This second method of replacement requires large capital expense to purchase expensive sources of energy like solar, fuel cells, or generators, requires fuel expense, produces carbon emissions, and often requires complex set up, maintenance and support, not to mention the time and labor associated with executing the switch over. Most companies do not have the resources to affordably control, manage, and measure this option. In summary, the method that we provide uses a curtailment approach to DR, not a replacement approach.

The system works as well to manage Demand Response: The system is installed with specialized IoT devices placed at many of the existing control points in a facility, such as light switches, outlets, HVAC, thermostats, machines, power strips, etc. As mentioned before, the system serves many energy management purposes in addition to DR, including PDM, general consumption management, as well as many other energy management benefits including reporting and analytics. The software is connected real time wirelessly to each of these devices through an existing wireless network in the facility, or through a specific wireless network that is implemented, or a combination of both. When a DR event is requested by the Utility, or ISO, it is typically done through an electronic signal initiated by the ISO/system operator, the signal is received by either a Curtailment Service provider (CSP) or an end user, with little lead time, and the system can automatically receive that request through (open ADR is a current standard) integration to that network. The system reacts in an automated manner to respond to this request and can be pre-configured to automatically meet the request for a DR event in the following manner:

The adaptor devices can be installed in a variety of pre-selected points of measurement and control, and will automatically provide the kW usage of each of these individual areas of usage through the unique integrated software application. We also place a facility level meter in the same top aggregate level as the utility meter, so we know the total amount of kW for the entire facility, which is also presented readily in the software. The software also enables a profile or series of profiles that can easily be configured. These profiles are simply a group of IoT devices installed in the facility and connected through a wireless network to the software that can each individually control and measure the use of energy, including but not limited to light switches, outlets, thermostats, machine controls, etc. This group of devices or profiles can be triggered through a work flow when a DR event is requested, which in turn can trigger profiles to execute automatically, or alternatively to send an alert to request a profile execution which the profile can then be triggered through an executed command. This automatically curtails energy at the level requested to meet the DR commitment. Since the system measures the exact usage of each IoT device, the system can both be set up to automatically shed load by including enough devices to meet the total kW required, as well as report after the fact that the DR kW requirement was met and for how long. The control actions for IoT devices can include, but is not limited to “half bank” lighting in certain areas that support this, dimming if it is available in the facility, changing the temperature requested by several degrees, or simply shutting down certain things for short durations, or even staggering “on/off” conditions of multiple equipment types like AC units or other categories or equipment or machines. By using this approach, a company can meet the requirements of DR and manage the entire cycle of testing, and actual execution at any time, and do so without ever having to introduce manual steps or efforts. Of course as noted, manual steps or simple confirmation steps can be inserted if an organization prefers that.

There are a number of existing challenges in the method and complexity of setting up a DR environment in an organization, which in the current methods available is very complex, expensive and often requires third parties which take a high percentage of the financial benefits. The method of DR described herein is much easier and cheaper to implement than current systems.

The second challenge involves DR response times. The present system requires little to no response time to react to DR requests, reducing response times dramatically. With the system, this execution can be immediate upon the request to curtail, whereas the current approach is often an hour or even a day lead time between Utility request and expected curtailment execution. The reason the system achieves this immediate automated method is through the integrated software and hardware approach. The system can also enable a Utility or ISO portal and create a direct link to this model between the supplier and user of energy. Of course, a pre alert system can still be used to warn the facility of these demand curtailment events.

A third challenge the system solves is the expense of sharing a percent of the DR rebates or credits with another 3^{rd} party which can often be greater than 50% for an energy customer. With the system, this fee expense is not necessary as the system is always on and available as a by-product of having the system implemented. The system is so easy to set up and execute, the need for third party assistance is removed.

The fourth challenge this system solves is the ease of performing the Utility/ISO required “test runs” of the program, given that the system removes most of the complexity and expense of fully executing DR.

The fifth challenge this system removes is the audit requirement that measures the amount of kW planned to be delivered upon a DR request, the amount actually delivered or executed, and the “after the fact” proof that it was delivered. The system provides all of these metrics and analytics as a by-product of implementing the system in the facility with little to no added costs or efforts.

This invention can mainstream more participants into DR programs than ever before practical, and reduce supplier costs materially resulting in lower energy costs for consumers. The system can also open new areas of curtailment that were too complex to manage in the current systems in use today, enabling smaller organizations to participate in DR programs, as well as providing more energy curtailment for larger organizations at much lower cost to all parties involved.

The last added benefit from both of these Demand Management applications described above for PDM and DR, is the recent availability of facility batteries from companies like Tesla now producing large enough battery systems to offset or even replace energy demand loads in any given facility. The system can predict the peak times that these batteries can be switched into the facility grid, or applied against a planned or measured shut down approach of specific devices with their corresponding energy load fully understood so the replacement model is executed, reported, and measured seamlessly, thereby satisfying the demand curtailment requirement of PDM, or DR as another complement, and providing yet another method and source of usage curtailment in a seamless easy to manage way. It is in this one area that measured replacement is facilitated using this method. As the cost of energy batteries comes down, this system will be become more useful for the mainstream energy customer.

Although the invention has been described with reference to a particular arrangement of parts, features and the like, these are not intended to exhaust all possible arrangements or features, and indeed many other modifications and variations will be ascertainable to those of skill in the art.

What is claimed is:

1. An energy demand management system for minimizing energy usage above a peak demand value associated with a facility comprising:
a plurality of adaptors which measure energy usage at the adaptor and include controllers for controlling energy usage, the plurality of adaptors configured to control energy usage devices at the facility downstream of an electrical meter of the facility;
a computer in communication with said plurality of adaptors via a network;
software executing on said computer which is configured to generate a control input for transmission to at least one of the plurality of adaptors, the control input being generated based on energy usage in comparison to a threshold of energy usage and a control rule to control one or more of the energy usage devices;
the threshold of energy usage associated with the peak demand value of electrical energy usage for the facility where a charge for energy usage by the facility below the threshold is of a first value and the charge for energy usage by the facility above the threshold is of a second value greater than the first value, wherein the second value is applicable based upon said threshold having been exceeded;
wherein the charge for energy usage remains at the second value for a time period after said threshold is exceeded such that after said threshold is exceeded and during the time period, the charge for energy usage by the facility is of the second value despite the energy usage of the facility being below the threshold; and
the control input curtails energy usage of one or more of the energy usage devices at the facility to avoid the peak demand value of energy usage of the facility.

2. The system of claim 1 wherein the control rule identifies at least one of the energy usage devices whose usage is not curtailed in the event of the threshold being anticipated to be exceeded.

3. The system of claim 1 wherein the control rule identifies at least one of the energy usage devices and is associated with a condition for when usage thereof is curtailed in the event of the threshold being anticipated to be exceeded.

4. The system of claim 1 wherein the control rule identifies at least one of the energy usage devices and is associated with a condition for when usage thereof is not curtailed in the event of the threshold being anticipated to be exceeded.

5. The system of claim 1 wherein the control rule identifies at least one of the energy usage devices which is turned off in the event of the threshold being anticipated to be exceeded.

6. The system of claim 1 wherein the control rule includes a single rule for one or more of the energy usage devices.

7. The system of claim 1 wherein the control rule includes a one or more rules for one or more of the energy usage devices.

8. The system of claim 1 wherein the peak demand value related to usage via the electrical meter.

9. The system of claim 1 wherein the electrical meter is a utility company electrical meter used for determining a charge for energy usage.

10. The system of claim 1 wherein said control rule further includes a ruleset for reducing energy usage at one of the plurality of adaptors based the threshold of energy usage.

11. The system of claim 1 further comprising a sensor pack having a housing containing a plurality of sensors and in wireless communication with one or more of said plurality of adaptors, wherein the housing of said sensor pack is separate from said plurality of adaptors such that said sensor pack is configured to be positioned remote from one or more of said plurality of adaptors and to have a power source separate from the one or more of said plurality of adaptors;

12. The system of claim 1 wherein said sensor pack communicates with the one or more of said plurality of adaptors via Bluetooth Low Energy (BLE).

13. The system of claim 1 further comprising a profile stored on a storage accessible by said computer wherein when the threshold is anticipated to be reached, the profile is indicative of at least one modification to curtail energy usage and maintain usage below the peak demand value associated with the threshold.

14. The system of claim 1 wherein the value of the peak demand value and the threshold are the same.

15. The system of claim 1 wherein the peak demand value is measured in units of electrical power.

16. The system of claim 1 wherein the peak demand value is measured in units of electrical energy

17. A system for management of energy usage comprising:
a plurality of adaptors which measure energy usage at the adaptor and include controllers for controlling energy usage;
a sensor pack having a housing containing a plurality of sensors and in wireless communication with one or more of said plurality of adaptors, wherein the housing of said sensor pack is separate from said plurality of adaptors such that said sensor pack is configured to be positioned remote from one or more of said plurality of adaptors and to have a power source separate from the one or more of said plurality of adaptors;
a computer in communication with said plurality of adaptors and receiving energy usage data from the plurality of adaptors and sensor data from said sensor pack;
software executing on said computer which controls energy usage at one or more of the plurality of adaptors based on control data which includes said sensor data.

18. The system of claim 17 wherein the power source separate from the one or more of said plurality of adaptors is a battery.

19. The system of claim 17 wherein the housing is configured to allow for removal or addition of ones of the plurality of sensors.

20. The system of claim 17 wherein the housing contains three or more sensors selected from the group consisting of: temperature sensor, humidity sensor, light sensor, occupancy sensor, audio sensor, infrared camera sensor, air quality sensor, and smoke sensor.

21. The system of claim 17 wherein the sensor pack communicates with the one or more of said plurality of adaptors via Bluetooth Low Energy (BLE).

22. An energy management system for controlling energy usage at a facility comprising:
one or more voltage regulation devices which are configured to modify an electrical potential drawn downstream of an electrical meter of the facility;
a computer in communication with said one or more voltage regulation devices;
software executing on said computer which is configured to generate a control input for transmission to at least one of the one or more voltage regulation devices, the control input being generated to modify the electrical potential;
one or more energy usage devices downstream of the one or more voltage regulation devices which receive electrical potential which is modified in accordance with the control input.

23. The system of claim 22 wherein the control input is generated in response to a request from an energy supplier to reduce usage.

24. The system of claim 23 wherein the computer and one or more voltage regulation devices communicate via a wireless connection

25. The system of claim 22 wherein the control input is generated based on a threshold of energy usage associated with a peak demand value of electrical energy usage for the facility where a charge for energy usage by the facility below the threshold is of a first value and the charge for energy usage by the facility above the threshold is of a second value greater than the first value, wherein the second value is applicable based upon said threshold having been exceeded;
wherein the charge for energy usage remains at the second value for a time period after said threshold is exceeded such that after said threshold is exceeded and during the time period, the charge for energy usage by the facility is of the second value despite the energy usage of the facility being below the threshold; and
the control input causes the electrical potential drawn downstream of the electrical meter to be reduced to avoid the peak demand value of energy usage of the facility.

26. The system of claim 25 wherein the control input is generated in response to a request from an energy supplier to reduce usage.
